(19) United States
(12) Patent Application Publication
(10) Pub. No.: US 2021/0120893 A1
(43) Pub. Date: Apr. 29, 2021

(54) FACE MASK

(71) Applicant: JEN-CHIH WENG, New Taipei City (TW)

(72) Inventor: JEN-CHIH WENG, New Taipei City (TW)

(21) Appl. No.: 16/882,760

(22) Filed: May 26, 2020

(30) Foreign Application Priority Data
Oct. 23, 2019 (TW) 108213937

(51) Int. Cl. A41D 13/11

(52) U.S. Cl. CPC A41D 13/1107; A41D 2500/30; A41D 2300/332; A41D 13/1161

(57) ABSTRACT

The face mask includes a main member and a number of fastening elements, respectively connected to two lateral sides of the main member. The main member includes a first ventilatory layer; a first electrostatic layer joined to an outer side of the first ventilatory layer, forming a first space in-between; a second electrostatic layer joined to an outer side of the first electrostatic layer, forming a second space in-between; a second ventilatory layer joined to an outer side of the second electrostatic layer, forming a third space in-between; and the first electrostatic layer and the second electrostatic layer have different densities and different fiber diameters. The air breathed by a user is slowed down as it passes through the first, second, and third spaces, and buffered in the second space, thereby preventing glasses fogging, achieving dual filtrations, and providing both ventilation and substance trapping.

### BACKGROUND OF THE INVENTION

### (a) Technical Field of the Invention

The present invention is generally related to face masks, and more particular to a face mask that prevents glasses fogging, achieves dual filtrations, and provides both ventilation and substance trapping.

### (b) Description of the Prior Art

A face mask is a device covering a wearer's mouth and nose to protect the wearer from inhaling hazardous substances, including germs, dusts, and droplets. Existing face masks are usually made of cloth or paper, and are often disposable after use.

There are various types of face masks such. Dust masks are used during construction or cleaning activities. Surgical masks are worn by patients and healthcare personnel to prevent infections. Different face masks protect against different airborne dangers and, therefore, it is important to wear an appropriate type of face mask in a specific environment.

There are two-layer, three-layer, and four-layer face masks, where the three-layer ones are most common. A three-layer mask includes, from outside to inside, a water-repellent layer, a filtration layer, and a hydrophilic layer. The water-repellent layer is to prevent droplets; the filtration layer captures germs and dusts in the air; the hydrophilic layer absorbs aerosols breathed by the wearer.

If the wearer also wears glasses, the face mask often causes fogging. Therefore, there is a type of face masks equipped with patches inside the face masks around the wing of nose to block the breathed air from permeating upward. The patches, however, may lead to difficulty in breathing. The prevention of fogging is also not satisfactory when the patches do not adhere tightly.

A four-layer mask often includes the layers of non-woven cloth and an electrostatic layer. Even with an additional layer of non-woven cloth, it does little help to prevent glasses fogging as the fibers of the non-woven cloth is too thick.

### SUMMARY OF THE INVENTION

Therefore, a novel face mask is disclosed that is able to prevent glasses fogging, achieve dual filtrations, and provide both ventilation and substance trapping.

A major objective of the present invention is to provide a first electrostatic layer, a second electrostatic layer, and a second space in-between to collect and absorb breathed air.

To achieve the objective, the face mask includes a main member and a number of fastening elements, respectively connected to two lateral sides of the main member. The main member includes a first ventilatory layer; a first electrostatic layer joined to an outer side of the first ventilatory layer, forming a first space in-between; a second electrostatic layer joined to an outer side of the first electrostatic layer, forming a second space in-between; a second ventilatory layer joined to an outer side of the second electrostatic layer, forming a third space in-between; and the first electrostatic layer and the second electrostatic layer have different densities and different fiber diameters.

Through the above structure, the air breathed by a user is slowed down as it passes through the first, second, and third spaces, and buffered in the second space, thereby preventing glasses fogging, achieving dual filtrations, and providing both ventilation and substance trapping.

The face mask of the present invention therefore overcomes the shortcomings of the conventional three-layer face masks or the conventional face masks with patches.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a face mask according to a first embodiment of the present invention.

FIG. 2 is a perspective break-down diagram showing the face mask of FIG. 1.

FIG. 3 is a cross-sectional diagram showing the face mask of FIG. 1 sectioned along its A-A line.

FIG. 4 is a side-view diagram showing the face mask of FIG. 1 worn by a user.

FIG. 5 is a schematic diagram showing how breathed air passes through the face mask of FIG. 1.

FIG. 6 is another schematic diagram showing how breathed air is trapped inside the face mask of FIG. 1.

FIG. 7 is yet another schematic diagram showing how breathed air permeates out of the face mask of FIG. 1.

FIG. 8 is a perspective diagram showing a face mask according to a second embodiment of the present invention.

FIG. 9 is a perspective diagram showing a face mask according to a third embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

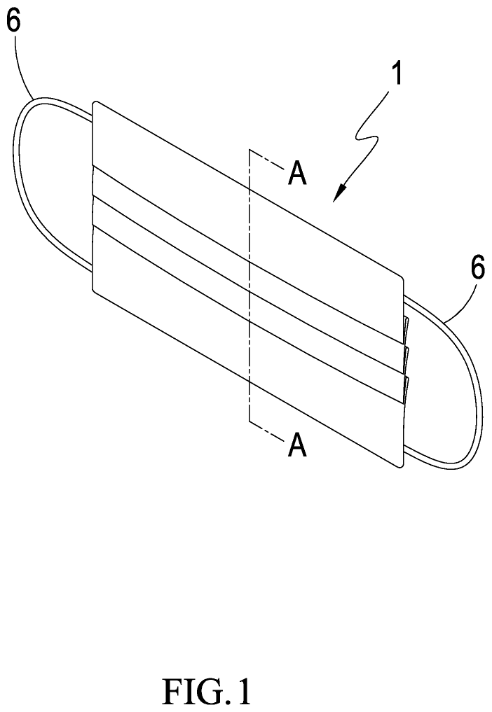

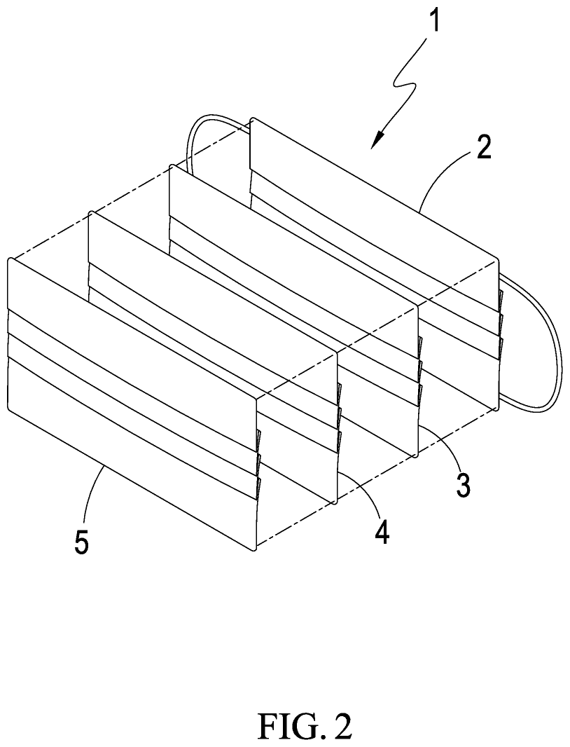

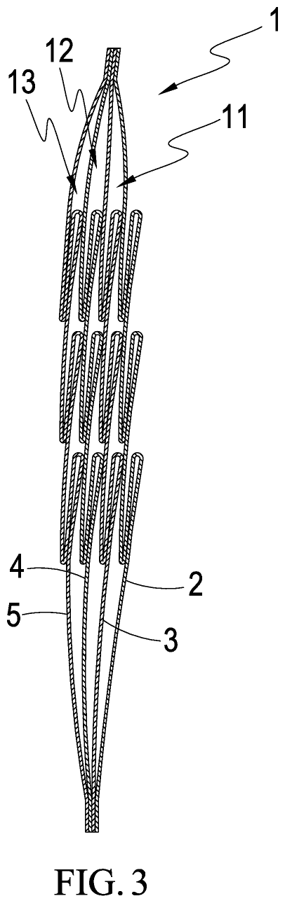

As shown in FIGS. 1 to 3, a face mask according to a first embodiment of the present invention includes a main member 1 and two fastening elements 6, respectively connected to two lateral sides of the main member 1. The main member 1 includes a first ventilatory layer 2, a first space 11, a first electrostatic layer 3, a second space 12, a second electrostatic layer 4, a third space 13, a second ventilatory layer 5. The first ventilatory layer 2, the first electrostatic layer 3, the second electrostatic layer 4, and the second ventilatory layer 5 are sequentially stacked in this order and their circumferences are bound together, thereby forming the first space 11, the second space 12, and the third space 13, respectively between the first ventilatory layer 2 and the first electrostatic layer 3, between the first electrostatic layer 3 and the second electrostatic layer 4, and between the second electrostatic layer 4 and second ventilatory layer 5.

In the present embodiment, the first ventilatory layer 2 is the innermost layer of the main member 1 that, when the face mask is worn by a user, it is the one that contacts with the user's face and mouth. The second ventilatory layer 5 is the outermost layer of the main member 1. The first electrostatic layer 3 and the second electrostatic layer 4 are of different densities of fibers and their fibers are also of different diameters. The fastening elements 6 are to secure the main member 1 to a user's head. They may be head ties, straps, or, in the present embodiment, elastic ear loops.

Based on the structure of the face mask described above, the face mask is able to prevent glasses fogging, achieve dual filtrations, and provide both ventilation and substance trapping.

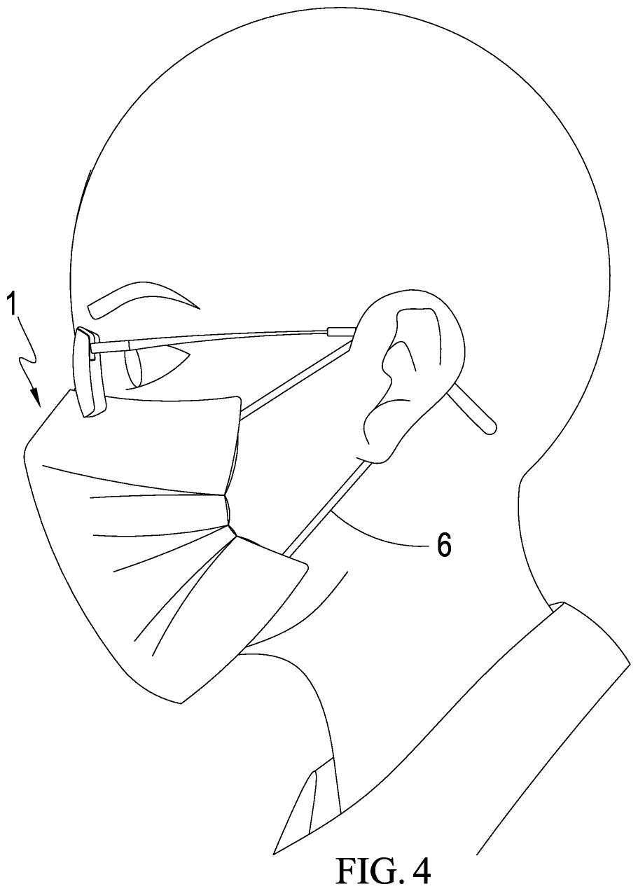

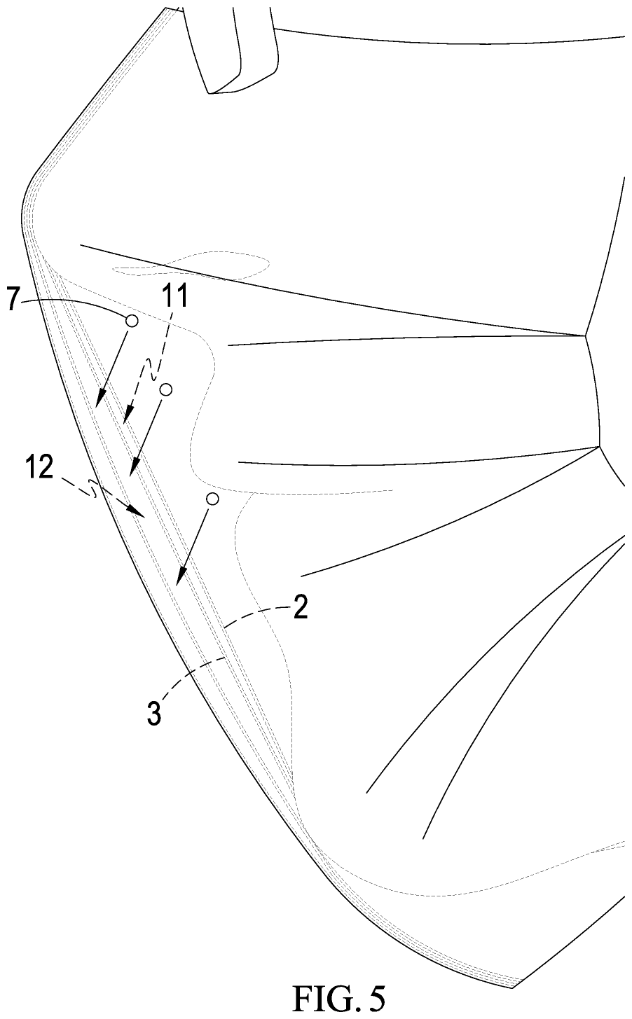

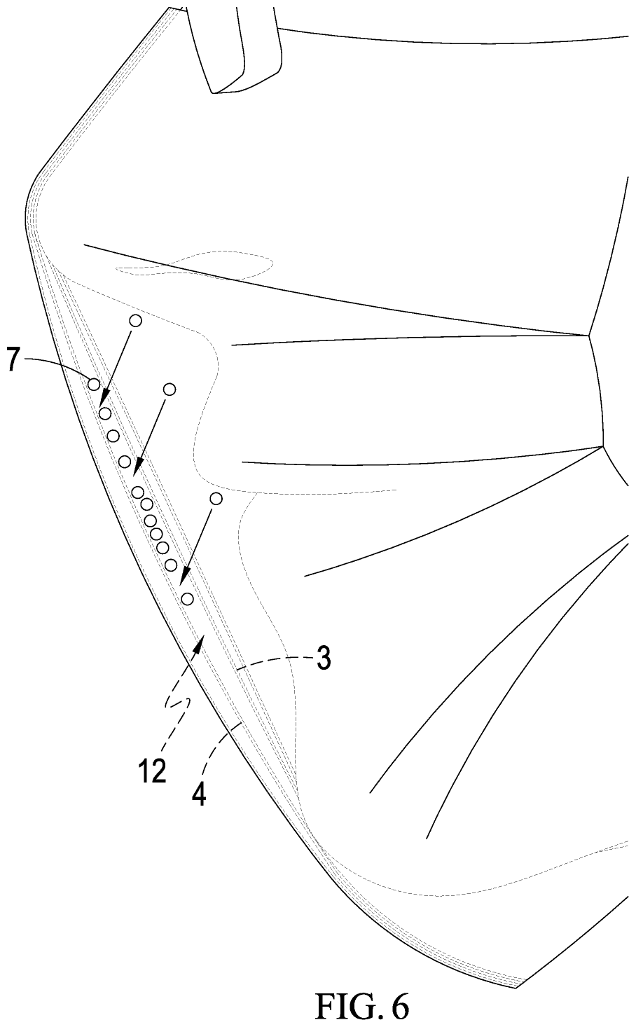

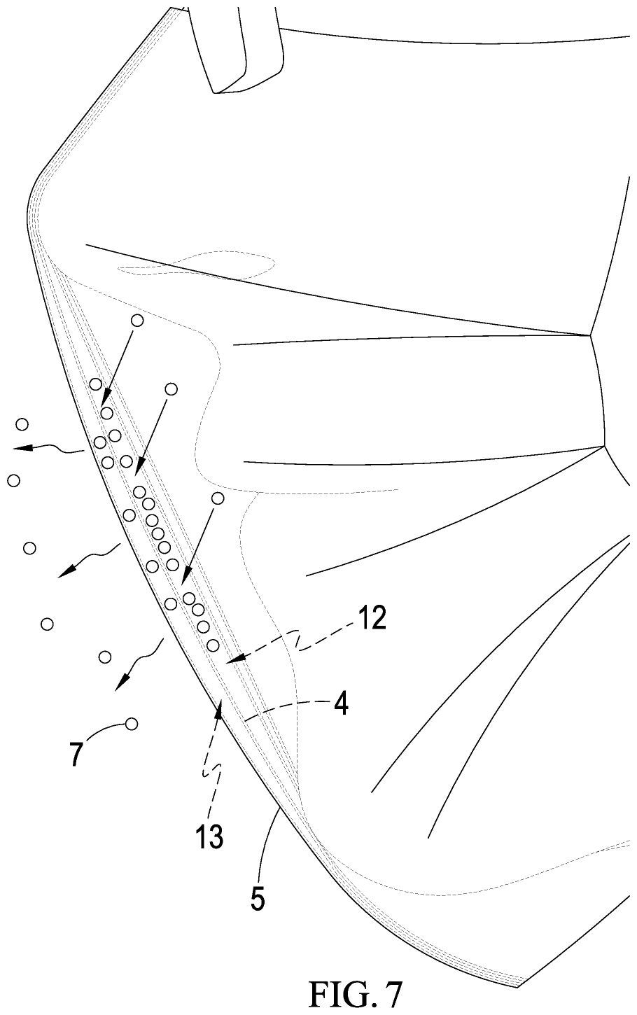

As shown in FIGS. 1 to 7, to wear the face mask, a user applies the fastening elements 6 around his/her ears to secure the main member 1. If the user also wears glasses, he/she can then put on the glasses. The user's breathed air 7 permeates sequentially through the first ventilatory layer 2, first space 11, first electrostatic layer 3, second space 12, second electrostatic layer 4, third space 13, second ventilatory layer 5, and then outside of the main member 1. In the present embodiment, the first ventilatory layer 2 is mainly for absorbing moist and the second ventilatory layer 5 is mainly for preventing droplets.

When the breathed air 7 passes through the first ventilatory layer 2, the first ventilatory layer 2 absorbs moist in the breathed air 7 and prevent moist from penetrating the first ventilatory layer 2. As a portion of the breathed air 7 reaches the first space 11 and contacts with the first electrostatic layer 3, the first electrostatic layer 3 filters dusts and germs in the breathed air 7 by its electrostatic charges, thereby trapping the dusts and germs in the first space 11.

After passing through the first electrostatic layer 3, the filtered breathed air 7 reaches the second space 12 and contacts with the second electrostatic layer 4, which provides additional filtration to the dusts and germs by its electrostatic charges and further slows down the permeation of the breathed air 7. The breathed air 7 is as such detained in the second space 12 and slowly permeate through the second electrostatic layer 4 into the third space 13.

The main function of the second ventilatory layer 5 is to block outside droplets and to prevent the user from inhaling dusts and germs. The second ventilatory layer 5 may also assist the second electrostatic layer 4 in further slowing down the breathed air 7. The breathed air 7, after passing through the second space 12, has to go through the additional second ventilatory layer 5 before getting out of the main member 1.

The reason that glasses get fogging is that the glasses has a lower temperature than that of the breathed air 7. When the warmer breathed air 7 contacts with the lenses of the glasses, the moist of the breathed air is condensed into small water drops attached to the lenses. However, the fogging often evaporates quickly and the fogging would remain only when there is a large amount of the breathed air 7 reaching the lenses. If the breathed air 7 slowly permeates through the face mask in small volumes, fogging may be reduced or even avoided.

Therefore, the breathed air 7, after the trapping and absorption by the second space 12 and the auxiliary blocking by the third space 13, would slowly permeate out of the main member 1, thereby avoiding a large amount of breathed air 7 to contact with the lenses and to form water drops on the lenses.

Similarly, when the user inhales, the breathed air 7 would sequentially pass through the second ventilatory layer 5, third space 13, second electrostatic layer 4, second space 12, first electrostatic layer 3, first space 11, first ventilatory layer 2, and finally into the user's body. In the process, the first electrostatic layer 3 and second electrostatic layer 4 provide dual filtrations. If dusts or germs are not filtered by and pass through the second electrostatic layer 4, the first electrostatic layer 3 further captures the escaped dusts and germs, thereby achieving superior filtration performance.

In addition, by having different fiber densities and different fiber diameters in the first electrostatic layer 3 and the second electrostatic layer 4, the breathed air 7 is further buffered in the process. Through the buffering by the first electrostatic layer 3 and second electrostatic layer 4, together with the trapping and gathering by the second space 12, the breathed air 7 would permeate slowly through the main member 1.

To quality as a surgical mask, a face mask has to offer above 95% filtration efficiency and lower than 5 mmH2O/cm2 pressure differential. The face mask of the present invention, through the different fiber densities and diameters of the first electrostatic layer 3 and second electrostatic layer 4, is not only able to achieve the above properties, but also able to strike an appropriate balance between effect filtration and fine ventilation,

The first electrostatic layer 3 and second electrostatic layer 4 have basis weight between 10 g/m2 and 30 g/m2 Then, the first electrostatic layer 3 and second electrostatic layer 4, while trapping the breathed air 7 and filtering dusts and germs, also provides superior ventilation. A user would not feel difficulty in breathing because of the first electrostatic layer 3, second electrostatic layer 4, and second space 12. Even though the face mask buffers the breathed air 7 in the second space 12, the breathed air 7 may still be released through the second electrostatic layer 4. The first electrostatic layer 3 and second electrostatic layer 4 only temporarily hold the breathed air 7 in the second space 12, and slowly release the buffered breathed air 7. Therefore, when the first electrostatic layer 3 and second electrostatic layer 4's basis weight falls within the above range, the face mask may prevent glasses fogging while maintaining fine ventilation function and substance trapping.

The basis weight of the first ventilatory layer 2 is between 17 g/m2 and 30 g/m2 In the present embodiment, the first ventilatory layer 2 has a basis weight 20 g/m2 However, this is only exemplary and the present invention is not limited as such. With such a first ventilatory layer 2, moist produced as the user breaths or speaks may be effectively absorbed. The basis weight 20 g/m2 also implies that the first ventilatory layer 2 has a low density and a low pressure differential. Therefore, the first ventilatory layer 2 provides excellent ventilation for the first electrostatic layer 3 and second electrostatic layer 4.

The basis weight of the second ventilatory layer 5 is between 15 g/m2 and 50 g/m2 In the present embodiment, the second ventilatory layer 5 has a basis weight 30 g/m2 However, this is only exemplary and the present invention is not limited as such. With such a second ventilatory layer 5, outside droplets may be effectively blocked. The basis weight 30 g/m2 also implies that the second ventilatory layer 5 provides excellent droplet blockage for the first electrostatic layer 3 and second electrostatic layer 4. As the breathed air 7 within the second space 12 passes through the second electrostatic layer 4 into the third space 13, its speed would be further slowed down as it tries to pass through the second ventilatory layer 5, thereby further reducing the chance of glasses fogging.

The first electrostatic layer 3 and the second electrostatic layer 4 are made of melt-blown non-woven cloth. Melt blowing is a fabrication method where a polymer melt is extruded through small nozzles and cut into fibers by a combination of heated and cool gas streams. The fibers then form a non-woven sheet cloth. Melt-blown non-woven cloth with electrostatic charges added can be used as an effective filter. The melt-blown non-woven cloth has small-diameter fibers and, therefore, provides large surface area, high porosity, and superior filtration. As such, not only that dusts and germs may be effectively filtered, the breathed air 7 may also be buffered in the second space 12 defined by the first electrostatic layer 3 and second electrostatic layer 4. first electrostatic layer 3 and second electrostatic layer 4, reducing the chance of glasses fogging.

It is mentioned above that the first electrostatic layer 3 and second electrostatic layer 4 have basis weight between 10 g/m2 and 30 g/m2 In the present embodiment, first electrostatic layer 3 and second electrostatic layer 4 have basis weight 15 g/m2 However, this is only exemplary and the present invention is not limited as such. As the first electrostatic layer 3 and second electrostatic layer 4 are structured with a same basis weight, they may be produced using a single mold or method, thereby reducing the production cost. In addition, when the first electrostatic layer 3 and second electrostatic layer 4 have basis weight 15 g/m2, an appropriate balance is achieved in slowing down the breathed air 7 and ventilation. The speed of the breathed air 7 released from the main member 1 is so slow that the breathed air 7 is not able to cause fogging on the lenses. In the meantime, the user may still breath easily.

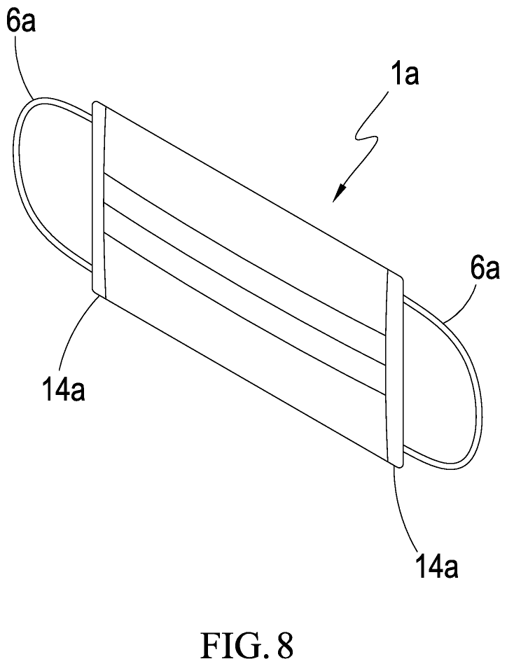

As shown in FIG. 8, a face mask according to a second embodiment of the present invention is similar to the previous embodiment but the main member 1a further includes at least a fastening strip 14a and each fastening element 6a's two ends are connected to the fastening strip 14a. In the present embodiment, there are two fastening strips 14a made of thin cloth, each arranged along a lateral edge of the main member 1a. The fastening strips 14a are for attaching the fastening elements 6a fixedly to the main member 1a, preventing them from breaking off.

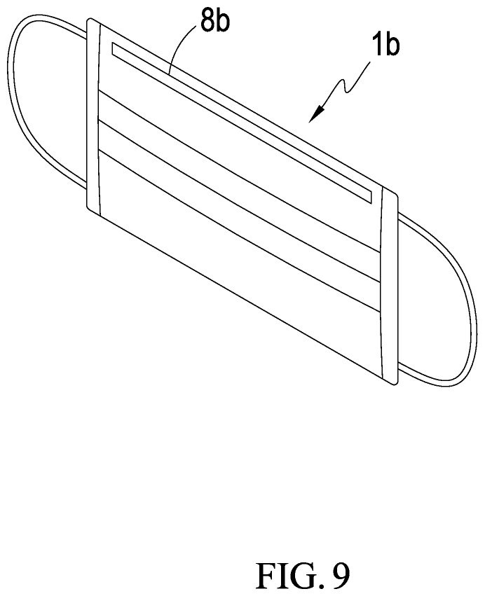

As shown in FIG. 9, a face mask according to a third embodiment of the present invention is similar to the previous embodiments but the main member 1b further includes a clipping element 8b which is a flexible and linear piece. In the present embodiment, the clipping element 8b is disposed along an upper edge of the main member 1b that would be above the bridge of the user's nose. By adjusting the clipping element 8b to conform to the shape of the nose bridge, the main member 1b would be tightly attached to the user's nose, preventing germs from escaping out of the upper edge of the main member 1b. The breathed air is also prevented from permeating upward to contact with glasses and causing fogging.

Therefore, the gist of the present invention lies in the following.

Firstly, through the provision of the first space 11, second space 12, and third space 13, the time for the breathed air 7 to pass through the main member 1 is lengthened.

Secondly, by buffering the breathed air 7 in the second space 12, the breathed air 7 is slowed down and does not contact with the lenses in a large volume, thereby preventing fogging.

Thirdly, by having first electrostatic layer 3 and second electrostatic layer 4 of different fiber densities and fiber diameters, an appropriate balance is achieved between the main member 1's filtration performance and pressure differential. The face mask therefore provides both filtration and ventilation.

Finally, as the first electrostatic layer 3 and second electrostatic layer 4 are both of basis weights between 10 g/m2 and 30 g/m2, the face mask is able to prevent glasses fogging while maintaining its ventilation.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A face mask, comprising a main member and a plurality of fastening elements, respectively connected to two lateral sides of the main member, wherein the main member comprises
a first ventilatory layer,
a first electrostatic layer circumferentially joined to an outer side of the first ventilatory layer, forming a first space in-between,
a second electrostatic layer circumferentially joined to an outer side of the first electrostatic layer, forming a second space in-between, and
a second ventilatory layer circumferentially joined to an outer side of the second electrostatic layer, forming a third space in-between; and
the first electrostatic layer and the second electrostatic layer have different densities and different fiber diameters.

2. The face mask according to claim 1, wherein the main member further comprises at least one fastening strip disposed along a lateral edge of the main member; and each fastening element's two ends are connected the at least one fastening strip.

3. The face mask according to claim 1, wherein the main member further comprises a clipping element along an upper edge of the main member.

4. The face mask according to claim 1, wherein the first electrostatic layer is made of melt-blown non-woven cloth.

5. The face mask according to claim 1, wherein the second electrostatic layer is made of melt-blown non-woven cloth.

6. The face mask according to claim 1, wherein the first and second electrostatic layers have a basis weight between 10 g/m2 and 30 g/m2.

7. The face mask according to claim 1, wherein first ventilatory layer has a basis weight between 17 g/m2 and 30 g/m2.

8. The face mask according to claim 1, wherein first ventilatory layer has a basis weight between 15 g/m2 and 50 g/m2.
